(19) United States
(12) Patent Application Publication
(10) Pub. No.: US 2003/0129950 A1
(43) Pub. Date: Jul. 10, 2003

(54) Antenna of wireless phone

(76) Inventor: Min-Woo Kwak, Sungnam--si (KR)

Correspondence Address: McGuireWoods, Tysons Corner, 1750 Tysons Boulevard, Suite 1800, McLean, VA, 22102-4215, US

(21) Appl. No.: 10/295,900

(22) Filed: Nov. 18, 2002

(30) Foreign Application Priority Data
Jan. 10, 2002 (KR) 2002-1434
Jan. 10, 2002 (KR) 2002-1435

(51) Int. Cl. H04B 1/38; H04M 1/00

(52) U.S. Cl. 455/90; 455/550; 455/575

(57) ABSTRACT

A built-in type antenna of a folder type wireless phone is disclosed, in which the antenna is extended to a folder in a non-contact manner using a hinge unit. The antenna includes a second coupling plate formed at a curved part of the hinge unit and connected with the antenna of the folder, and a first coupling plate provided in a main body facing to the hinge unit and connected with the antenna of the main body, wherein the first coupling plate and the second coupling plate overlap each other to have a uniform opening within the range of a rotational angle area that opens and closes the folder.

### BACKGROUND OF THE INVENTION

1. Field of the Invention

The present invention relates to a built-in antenna of a folder type wireless phone, and more particularly to a folder type wireless phone in which a main body and a folder can mechanically be opened and closed by a hinge unit and an antenna is extended to the folder in a non-contact manner using the hinge unit.

2. Discussion of the Related Art

One example of an antenna built in a folder using a hinge unit that connects a main body with the folder is disclosed in the Korean Patent Application No. 1998-41839.

Such a related art wireless phone having a structure of an antenna extended to a folder using a hinge unit will be described with reference to FIGS. 1 and 2.

The folder type wireless phone includes a main body 1, and a hinge unit 3 that connects the main body 1 with a folder 2. The hinge unit 3 is respectively provided at both sides of a liquid crystal display (LCD) 4. The folder 2 is opened and closed around a central shaft where the hinge unit 2 is positioned.

The main body 1 includes an antenna housing 5 in which an antenna is extendibly built. The LCD 4 is formed at a lower portion of the antenna housing in the main body 1. A key pad and mike unit 8 are formed below the LCD 4 and covered with the folder 2.

Meanwhile, the folder 2 includes an antenna 6 and a speaker 7. A neck 9 is extended to both sides of the folder 2 and is connected with the hinge unit of the main body 1 by means of a folder dummy 10. An antenna wire 11 formed in the folder 2 is provided toward the main body 1 through a through hole formed in the neck 9 of the folder and a through hole 13 of a cylinder 12 formed in the folder dummy 10. The antenna wire 11 is electrically connected with a main board of the main body through the through hole 13 of the folder dummy 10.

The aforementioned related art wireless phone that connects an antenna wire with the hinge unit through a hole formed in the hinge unit has several problems.

Friction repeatedly occurs between the antenna wire and the folder dummy due to rotation of the folder dummy 10 in the process of opening and closing the folder. The repeated friction causes disconnection of the antenna wire, or causes covering of the wire to be removed. In addition, since the wire or the hole that passes through the antenna is separately required, the structure of the hinge unit becomes complicated.

### SUMMARY OF THE INVENTION

The present invention is directed to an antenna of a wireless phone that substantially obviates one or more of the problems due to limitations and disadvantages of the related art.

An object of the present invention is to provide an antenna of a wireless phone that can prevent disconnection of the antenna by connecting a first antenna formed in a main body with a second antenna formed in a folder.

Another object of the present invention is to provide an antenna of a wireless phone that connects a folder with an antenna of a main body using a first coupling plate and a second coupling plate without changing a structure of a hinge unit.

Another object of the present invention is to provide an antenna of a wireless phone that can vary capacitance formed between first and second coupling plates by varying an overlap area between the first and second coupling plates in accordance with a rotational angle of a hinge unit and can selectively switch a second antenna connected with the second coupling plate using the variation of the capacitance.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, an antenna of a wireless phone according to the present invention includes a first antenna formed in a main body and a second antenna formed in a folder, wherein the first antenna is connected with a duplexer through an antenna matching circuit, which enables bi-directional communication, and is also connected with the second antenna in a non-contact manner using a pair of coupling plates (first coupling plate and second coupling plate).

The first coupling plate is connected with the first antenna of the main body and the second coupling plate is connected with the second antenna of the folder.

Particularly, the coupling plates are spaced apart from each other at a predetermined interval, and the second coupling plate connected with the second antenna is fixed along a curved part of a hinge unit and rotates as the hinge unit rotates. The first coupling plate connected with the first antenna is fixed to a recessed groove formed in the main body corresponding to the rotational position of the hinge unit to face to the second coupling plate.

The second coupling plate fixed to the hinge unit is formed to overlap the first coupling plate fixed to a groove of a curved part of the main body at a constant interval. The overlap area is uniformly maintained regardless of the rotational position of the hinge unit. The first coupling plate and the second coupling plate have an overlap area with a constant opening within the range of a rotational angle of the hinge unit and a non-overlap area where the first coupling plate does not overlap the second coupling plate.

To further achieve these and other advantages and in accordance with the purpose of the present invention, in an antenna of a wireless phone including a hinge unit that connects a main body with a folder, the folder being opened in accordance with rotation of the hinge unit and the antenna being formed in the main body to extend to the folder, the antenna of a wireless phone includes a second coupling plate formed at a curved part of the hinge unit and connected with the antenna of the folder, and a first coupling plate provided in the main body facing to the hinge unit and connected with the antenna of the main body, wherein the first coupling plate and the second coupling plate overlap each other to have the same area and a uniform opening within the range of a rotational angle area that opens and closes the folder.

To further still achieve these and other advantages and in accordance with the purpose of the present invention, in an antenna of a wireless phone including a hinge unit that connects a main body with a folder, the folder being opened in accordance with rotation of the hinge unit and the antenna being formed in the main body to extend to the folder, the antenna of a wireless phone includes a second coupling plate formed at a curved part of the hinge unit and connected with the antenna of the folder, and a first coupling plate provided in the main body facing to the hinge unit and connected with the antenna of the main body, wherein the first coupling plate and the second coupling plate have an overlap area with a uniform opening within the range of a rotational angle of the hinge unit and a non-overlap area.

The overlap area between the first and second coupling plates has a curved shape.

The first and second coupling plates are formed of a conductive film and fixed to the hinge unit by molding.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 illustrates a structure of a related art wireless phone;

FIG. 2 illustrates a structure of a folder provided in the wireless phone of FIG. 1;

FIG. 3 illustrates a built-in structure of an antenna of a wireless phone according to the first embodiment of the present invention;

FIG. 4 is an exploded perspective view illustrating an enlarged hinge unit of the wireless phone of FIG. 3;

FIG. 5 illustrates a position structure of coupling plates of first and second antennas in a state where a folder is closed, in accordance with the wireless phone according to the first embodiment of the present invention;

FIG. 6 illustrates a position structure of coupling plates of first and second antennas in a state where a folder is opened, in accordance with the wireless phone of the first embodiment of the present invention;

FIG. 7 illustrates an equivalent circuit of a contact part of coupling plates of first and second antennas in accordance with the wireless phone of the first embodiment of the present invention;

FIG. 8 illustrates a built-in structure of an antenna of a wireless phone according to the second embodiment of the present invention;

FIG. 9 is an exploded perspective view illustrating an enlarged hinge unit of the wireless phone of FIG. 8;

FIG. 10 illustrates a position structure of coupling plates of first and second antennas in a state where a folder is closed, in accordance with the wireless phone of the second embodiment of the present invention;

FIG. 11 illustrates a built-in structure of coupling plates of first and second antennas in a state where a folder is opened, in accordance with the wireless phone of the second embodiment of the present invention; and

FIG. 12 illustrates an equivalent circuit of a contact part of coupling plates of first and second antennas, in accordance with the wireless phone of the second embodiment of the present invention.

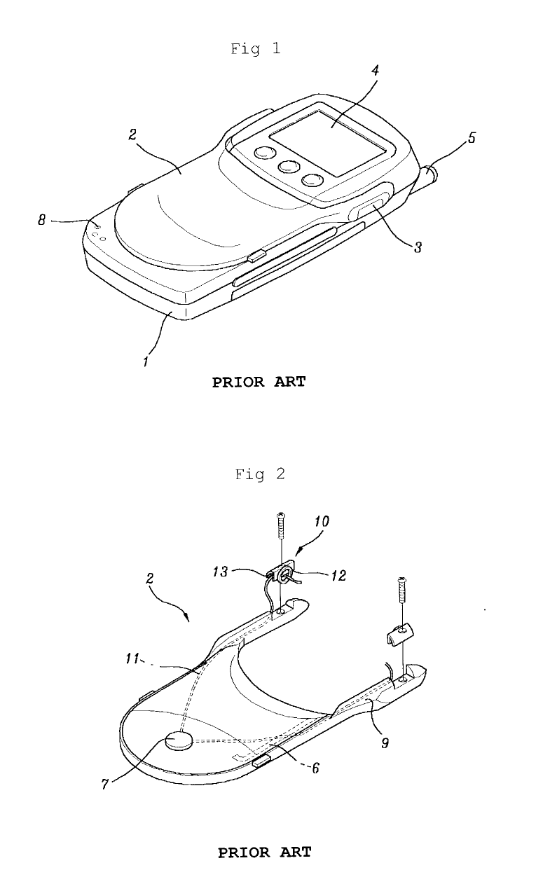

### DETAILED DESCRIPTION OF THE PREFERRED EMBODIMENTS

Reference will now be made in detail to the preferred embodiments of the present invention, examples of which are illustrated in the accompanying drawings.

First Embodiment

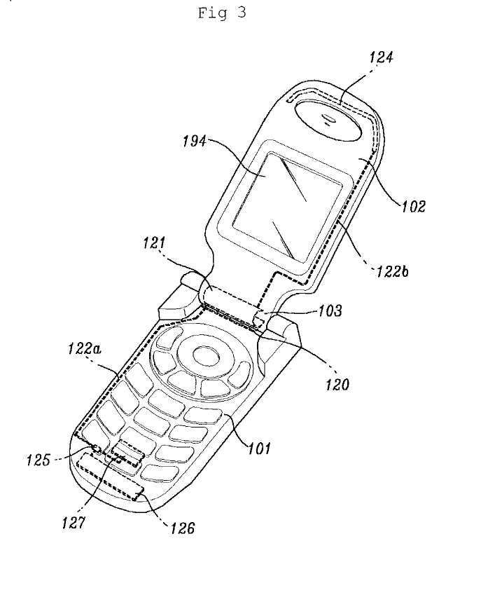

A structure of an antenna of a wireless phone according to the first embodiment of the present invention will be described with reference to FIGS. 3 to 7.

As shown in FIG. 3, a first antenna 126 is built in a main body 101 having a circuit means and a number key, and a second antenna 124 is built in a folder 102 having an LCD window 104. The first antenna 126 is connected with a duplexer 127 through an antenna matching circuit 125 to enable bi-directional communication and is also connected with the second antenna formed in the folder 102.

The first antenna 126 is electrically connected with a first coupling plate 120 provided below the hinge unit 103. The hinge unit 103 acts to connect the main body 101 with the folder 102.

The second antenna 124 is electrically connected with a second coupling plate 121 formed in a main body of the hinge unit 103, through an antenna wire 122b. The first coupling plate 120 and the second coupling plate 121 are formed in such a manner that an opening between them is uniform even if the hinge unit rotates to open and close the folder and an overlap area between them is always constant.

In other words, even if the second coupling plate 121 fixed to the main body of the hinge unit rotates as the folder is opened or closed, it has a constant overlap area with the first coupling plate 120 regardless of the rotational angle. To uniformly maintain the overlap area and the opening between the first and second coupling plates, the second coupling plate 121 is provided along a curved part of the hinge unit and the first coupling plate 120 fixed to the main body 1 is configured to face to a curved part of the second coupling plate 121.

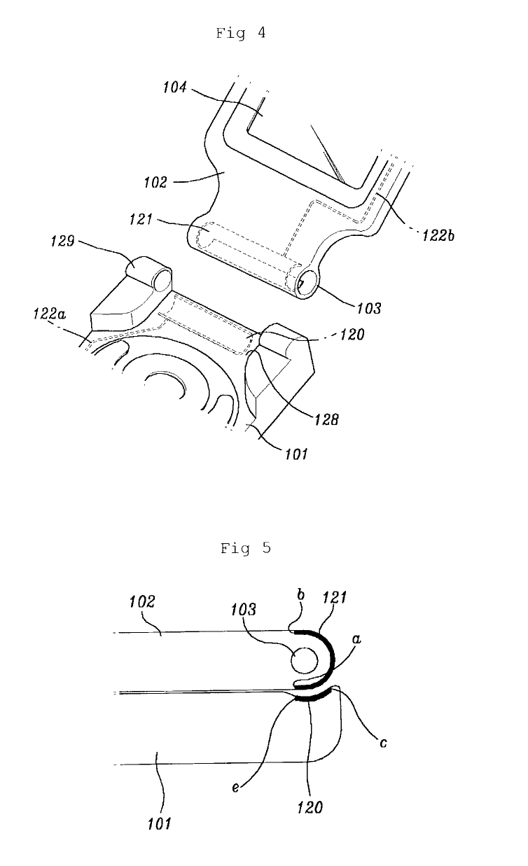

The connection structure of the coupling plates will be described in more detail with reference to FIGS. 4, 5, and 6.

The second coupling plate 121 is fixed along the curved part of the main body of the hinge unit 103 connected with the folder 102. The second coupling plate 121 may be fixed by either molding when a case of the folder is formed by ejection or a separate fixed means. The antenna wire 122b may be connected with the second coupling plate 121 to form a single body with the second coupling plate 121, or may be connected with the second coupling plate 121 by a separate solder operation.

Meanwhile, at a rotational position where the hinge unit 103 is fixed to the main body 101, the first coupling plate 120 is fitted into a curved groove 128 formed in the main body 101.

In the same manner as the second coupling plate, the first coupling plate may be fixed to the main body by molding ejection.

After the first coupling plate and the second coupling plate are respectively fixed to the main body and the hinge unit 103, when the hinge unit is fixed to a hinge fitting part 129 of the main body, the first and second coupling plates 120 and 121 are formed in such a manner that an overlap area between them has a constant opening ‘d’ in a state where they are not in contact with each other.

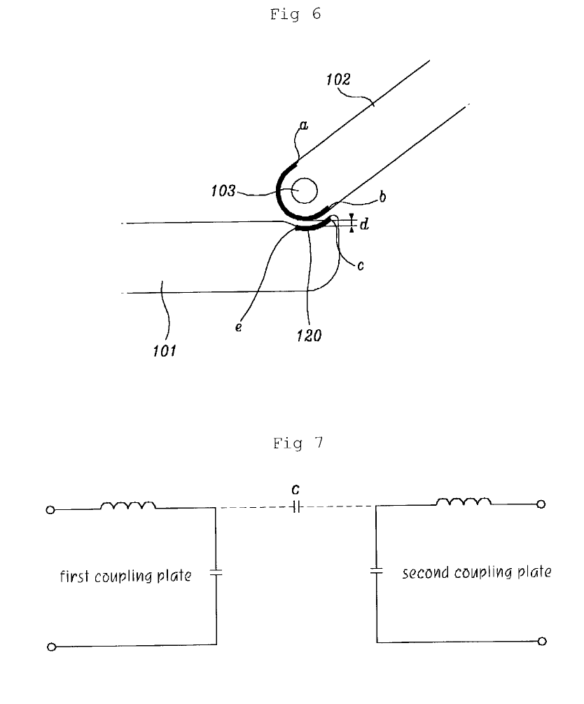

Regardless of the state where the wireless phone is closed as shown in FIG. 5 or it is opened as shown in FIG. 6, the overall area of the first coupling plate 120 overlaps the second coupling plate 121. That is, even if the hinge unit rotates to open and close the folder, the first coupling plate and the second coupling plate have a constant overlap area regardless of the rotational position of the hinge unit.

As described above, to maintain the state where the first coupling plate and the second coupling plate have the same overlap area, the folder 102 should be rotated within the range that the positions (a) and (b) of the second coupling plate include the positions (e) and (c) of the first coupling plate 120.

In the antenna of the wireless phone according to the first embodiment of the present invention, the first coupling plate overlaps the second coupling plate at a constant area in a non-contact manner while forming a certain opening. Thus, it is possible to obtain capacitance that synchronizes the first antenna with the second antenna between a pair of the coupling plates as shown in FIG. 7. The capacitance acts to directly connect the first and second antennas with the wire.

Second Embodiment

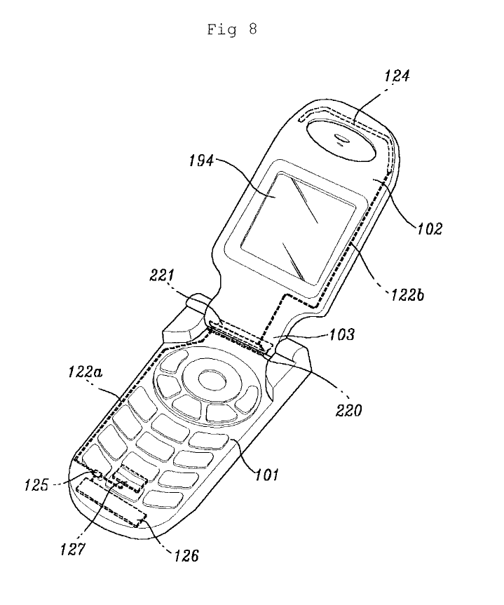

A structure of an antenna of a wireless phone according to the second embodiment of the present invention will be described with reference to FIGS. 8 to 12.

As shown in FIG. 8, a first antenna (PIFA) 126 is built in a main body 101 having a circuit means and a number key, and a second antenna 124 is built in a folder 102 having an LCD window 104. The first antenna 126 is connected with a duplexer 127 through an antenna matching circuit 125 to enable bi-directional communication and is also connected with the second antenna 124 formed in the folder 102.

The first antenna 126 is electrically connected with a first coupling plate 220 provided below a hinge unit 103.

The second antenna 124 is electrically connected with a second coupling plate 221 formed in a main body of the hinge unit 103, through an antenna wire 122b. The first coupling plate 220 and the second coupling plate 221 have an overlap area and a non-overlap area. In the overlap area, predetermined areas overlap each other at a uniform opening when the hinge unit rotates to open and close the folder.

In other words, when the second coupling plate 221 fixed to the main body of the hinge unit rotates at a predetermined angle as the folder is opened or closed, a maximum overlap area set by a technical operator is formed between the second coupling plate 221 and the first coupling pate 220.

If the folder 102 rotates in a state where the maximum overlap area is formed, the overlap area between the first and second coupling plates is reduced in accordance with variation of the rotational angle. As a result, the first and second coupling plates reach the non-overlap area.

Meanwhile, to uniformly maintain the opening ‘d’ between the pair of plates regardless of the rotational angle, the second coupling plate 221 is provided along a curved part of the hinge unit while the first coupling plate 220 fixed to the main body 101 is provided to face to a curved part of the second coupling plate 221.

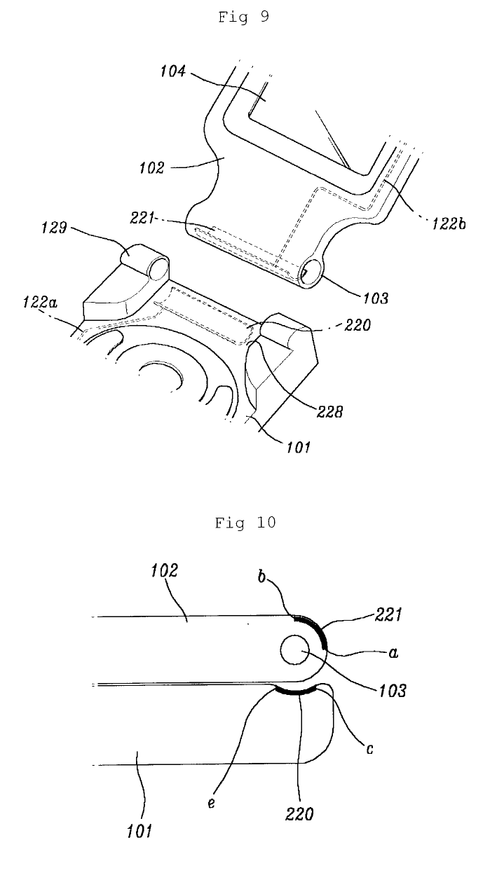

The connection structure of the coupling plates will be described in more detail with reference to FIG. 9.

The second coupling plate 221 is fixed along the curved part of the main body of the hinge unit 103 connected with the folder 102. The second coupling plate 221 may be fixed by either molding when a case of the folder is formed by ejection or a separate fixed means. The antenna wire 122b may be connected with the second coupling plate 221 to form a single body with the second coupling plate 221, or may be connected with the second coupling plate 221 by a separate solder operation.

At a rotational position where the hinge unit 103 is fixed to the main body 101, the first coupling plate 220 is fitted into a curved groove 228 formed in the main body 101.

In the same manner as the second coupling plate, the first coupling plate may be fixed to the main body by molding ejection.

As an example, no overlap area is formed between the first and second coupling plates 220 and 221 in a state where the folder is closed as shown in FIG. 10, and an overlap area is formed as shown in FIG. 11 in a state where the folder is opened to enable communication.

As the case may be, the overlap area may be formed between the first and second coupling plates in a state where the folder is closed, and no overlap area may be formed between the first and second coupling plates in a state where the folder is opened. The first and second coupling plates are provided in such a manner that the overlap area has a predetermined uniform opening ‘d’ in a state where the first and second coupling plates are not in contact with each other. As shown in FIG. 10, the first and second coupling plates are formed in such a manner that they have two rotational angle areas of the hinge unit. In the one rotational angle area, the positions (a) and (b) of the second coupling plate 221 are away from the positions (e) and (c) of the first coupling plate 220 as shown in FIG. 10. In the other rotational angle area, the positions (a) and (b) of the second coupling plate 221 cover the positions (e) and (c) of the first coupling plate 220 as shown in FIG. 11.

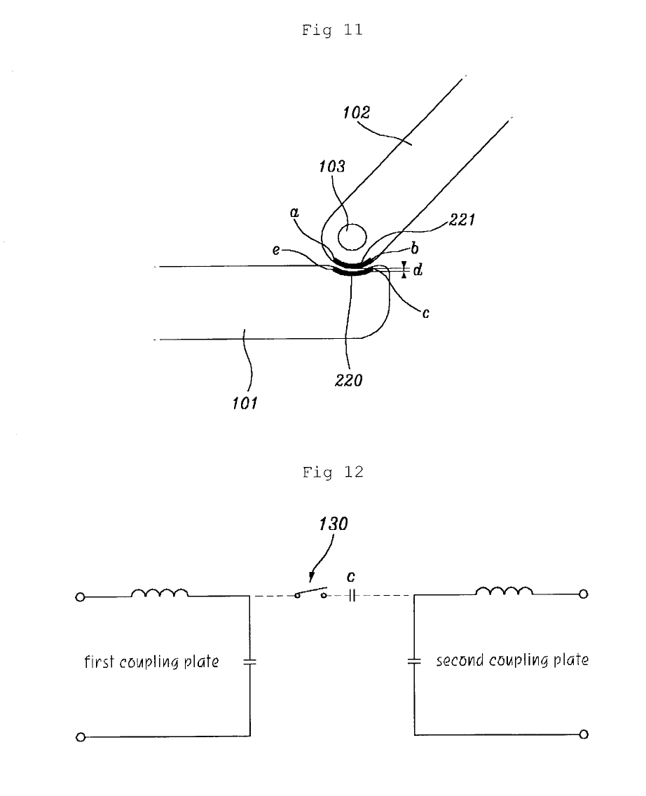

In the second embodiment, the overlap area between the first and second coupling plates is switched in a non-contact manner, so that the variable capacitance that synchronizes the first antenna with the second antenna can be obtained between the pair of coupling plates as shown in FIG. 12.

Therefore, it is possible to selectively switch the second antenna. That is, it is possible to obtain the same advantage that a switching element 130 of the second antenna is additionally provided.

As aforementioned, the antenna of a wireless phone according to the present invention has the following advantages.

First, it is possible to provide an antenna structure that can prevent disconnection of the antenna by connecting the first antenna formed in the main body with the second antenna formed in the folder in a non-contact manner using the pair of coupling plates formed in the hinge unit.

Also, it is possible to connect the folder with the antenna of the main body without changing the structure of the hinge unit.

Finally, the capacitance formed between the first and second coupling plates can be varied by varying the overlap area between the first and second coupling plates in accordance with the rotational angle of the hinge unit, thereby selectively switching the second antenna.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. In an antenna of a wireless phone including a hinge unit that connects a main body with a folder, the folder being opened in accordance with rotation of the hinge unit and the antenna being formed in the main body to extend to the folder, the antenna of a wireless phone comprising:
a second coupling plate formed at a curved part of the hinge unit and connected with the antenna of the folder; and
a first coupling plate provided in the main body facing to the hinge unit and connected with the antenna of the main body,
wherein the first coupling plate and the second coupling plate overlap each other to have the same area and a uniform opening within the range of a rotational angle area that opens and closes the folder.

2. In an antenna of a wireless phone including a hinge unit that connects a main body with a folder, the folder being opened in accordance with rotation of the hinge unit and the antenna being formed in the main body to extend to the folder, the antenna of a wireless phone comprising:
a second coupling plate formed at a curved part of the hinge unit and connected with the antenna of the folder; and
a first coupling plate provided in the main body facing to the hinge unit and connected with the antenna of the main body,
wherein the first coupling plate and the second coupling plate have an overlap area with a uniform opening within the range of a rotational angle of the hinge unit and a non-overlap area.

3. The antenna of a wireless phone according to claim 1 or 2, wherein the overlap area between the first and second coupling plates has a curved shape.

4. The antenna of a wireless phone according to claim 1 or 2, wherein the first and second coupling plates are formed of a conductive film.

5. The antenna of a wireless phone according to claim 1 or 2, wherein the first and second coupling plates are fixed to the hinge unit by molding.
